(19) United States
(12) Patent Application Publication
(10) Pub. No.: US 2026/0116074 A1
(43) Pub. Date: Apr. 30, 2026

(54) LIQUID EJECTION DEVICE AND WIPING DEVICE

(71) Applicant: SEIKO EPSON CORPORATION, TOKYO (JP)

(72) Inventor: Satoru KOBAYASHI, Shiojiri-shi (JP)

(21) Appl. No.: 19/367,929

(22) Filed: Oct. 24, 2025

(30) Foreign Application Priority Data
Oct. 25, 2024 (JP) 2024-187894

(51) Int. Cl. B41J 2/17; B41J 2/165

(52) U.S. Cl. CPC B41J 2/1714; B41J 2/16544; B41J 2002/1655

(57) ABSTRACT

A liquid ejection device includes: a head having a nozzle surface where a nozzle that ejects a liquid is opened; a wiping member that wipes the nozzle surface; a reel-out unit around which the wiping member is wound; a wind-up unit that winds up the wiping member; a pressing unit that presses the wiping member against the nozzle surface; and a first curing unit that applies energy to the liquid and thus cures the liquid. The wiping member is formed of at least two layers including a first layer and a second layer that is farther from the nozzle surface than the first layer and is adjacent to the first layer, and the first layer and the second layer are brought into a separated state in a path between the pressing unit and the wind-up unit. The first curing unit applies energy to the first layer and the second layer at a position between the first layer and the second layer in the separated state.

The present application is based on, and claims priority from JP Application Serial Number 2024-187894, filed October 25, 2024, the disclosure of which is hereby incorporated by reference herein in its entirety.

### BACKGROUND

### 1. Technical Field

The present disclosure relates to a liquid ejection device and a wiping device.

### 2. Related Art

For example, JP-A-2022-119307 discloses a liquid ejection device including a head having a nozzle surface where a plurality of nozzles that eject a liquid are opened. In such a liquid ejection device, a curing unit that applies energy to the liquid and thus cures the liquid, and an absorber, which is an example of a wiping member that collects the liquid as a waste liquid, are provided.

JP-A-2022-119307 is an example of the related art.

However, in such a liquid ejection device, when the wiping member is thick, the energy from the curing unit does not sufficiently reach the inside. Thus, the wiping member may not be sufficiently dried and contamination or odor may occur in the liquid ejection device.

### SUMMARY

According to an aspect of the present disclosure, a liquid ejection device includes: a head having a nozzle surface where a nozzle that ejects a liquid is opened; a wiping member configured to wipe the nozzle surface; a reel-out unit around which the wiping member is wound; a wind-up unit configured to wind up the wiping member; a pressing unit configured to press the wiping member against the nozzle surface; and a first curing unit configured to apply energy to the wiping member and thus cure the liquid wiped by the wiping member, wherein the wiping member is formed of at least two layers including a first layer and a second layer that is farther from the nozzle surface than the first layer and is adjacent to the first layer, the first layer and the second layer are brought into a separated state in a path between the pressing unit and the wind-up unit, and the first curing unit applies energy to the first layer and the second layer at a position between the first layer and the second layer in the separated state.

According to another aspect of the present disclosure, a liquid ejection device includes: a head having a nozzle surface where a nozzle that ejects a liquid is opened; a wiping member configured to wipe the nozzle surface; a reel-out unit around which the wiping member is wound; a wind-up unit configured to wind up the wiping member; a pressing unit configured to press the wiping member against the nozzle surface; a second curing unit configured to apply energy to the wiping member and thus cure the liquid wiped by the wiping member; and a third curing unit configured to apply energy to the wiping member and thus cure the liquid wiped by the wiping member, wherein the wiping member is formed of at least two layers including a first layer and a second layer that is farther from the nozzle surface than the first layer and is adjacent to the first layer, the first layer and the second layer are brought into a separated state in a path between the pressing unit and the wind-up unit, the second curing unit applies energy to the first layer at a position opposite the second layer in the separated state, with the first layer in the separated state located therebetween, and the third curing unit applies energy to the second layer at a position opposite the first layer in the separated state, with the second layer in the separated state located therebetween.

According to still another aspect of the present disclosure, a wiping device includes: a wiping member configured to wipe a nozzle surface where a nozzle that ejects a liquid is opened; a reel-out unit around which the wiping member is wound; a wind-up unit configured to wind up the wiping member; a pressing unit configured to press the wiping member against the nozzle surface; and a first curing unit configured to apply energy to the wiping member and thus cure the liquid wiped by the wiping member, wherein the wiping member is formed of at least two layers including a first layer and a second layer that is farther from the nozzle surface than the first layer and is adjacent to the first layer, the first layer and the second layer are brought into a separated state in a path between the pressing unit and the wind-up unit, and the first curing unit applies energy to the first layer and the second layer at a position between the first layer and the second layer in the separated state.

According to still another aspect of the present disclosure, a wiping device includes: a wiping member configured to wipe a nozzle surface where a nozzle that ejects a liquid is opened; a reel-out unit around which the wiping member is wound; a wind-up unit configured to wind up the wiping member; a pressing unit configured to press the wiping member against the nozzle surface; a second curing unit configured to apply energy to the wiping member and thus cure the liquid wiped by the wiping member; and a third curing unit configured to apply energy to the wiping member and thus cure the liquid wiped by the wiping member, wherein the wiping member is formed of at least two layers including a first layer and a second layer that is farther from the nozzle surface than the first layer and is adjacent to the first layer, the first layer and the second layer are brought into a separated state in a path between the pressing unit and the wind-up unit, the second curing unit applies energy to the first layer at a position opposite the second layer in the separated state, with the first layer in the separated state located therebetween, and the third curing unit applies energy to the second layer at a position opposite the first layer in the separated state, with the second layer in the separated state located therebetween.

### BRIEF DESCRIPTION OF THE DRAWINGS

FIG. 1 is a schematic view showing a liquid ejection device according to a first embodiment.

FIG. 2 is a table showing the relationship between a wind-up unit and the amount of wind-up according to a second embodiment.

FIG. 3 is a schematic view showing a liquid ejection device according to a third embodiment.

### DESCRIPTION OF EMBODIMENTS

### First Embodiment

An embodiment of a liquid ejection device including a wiping device will now be described with reference to the drawings. In the description below, directions intersecting vertical directions Z are defined as width directions Y, and directions intersecting the vertical directions Z and the width directions Y are defined as intersecting directions X. One of the width directions Y is defined as a first width direction Y1, and the other of the width directions Y is defined as a second width direction Y2. One of the intersecting directions X is defined as a first intersecting direction X1, and the other of the intersecting directions X is defined as a second intersecting direction X2. The upward direction of the vertical directions Z is referred to as an upward direction Z1, and the downward direction of the vertical directions Z is referred to as a downward direction Z2.

### Configuration of Liquid Ejection Device 11

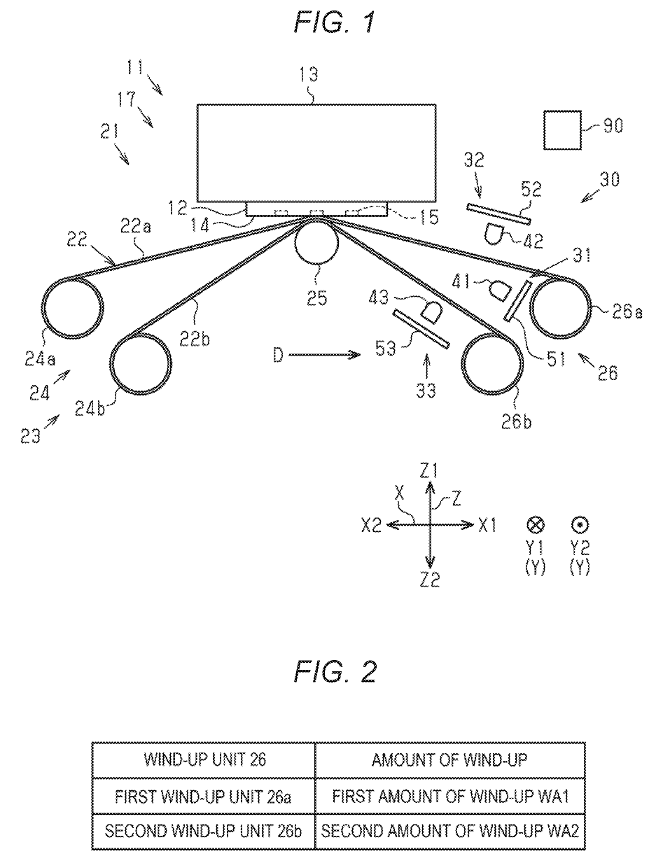

A liquid ejection device 11 is configured to eject a liquid onto a medium and thus perform printing on the medium, as shown in FIG. 1. The liquid may include, for example, an ink. The liquid may include a liquid that is cured by application of energy. The liquid may include, for example, a liquid that is cured by irradiation with ultraviolet rays. The liquid may have, for example, a plurality of colors. The liquid ejection device 11 may be an inkjet printer.

The liquid ejection device 11 includes a head 12 and a carriage 13. The head 12 is configured to eject the liquid. The head 12 in the present embodiment ejects the liquid in the downward direction Z2. The head 12 is configured to be supported by a bottom surface of the carriage 13.

The head 12 includes a nozzle surface 14. The nozzle surface 14 is a surface where a nozzle 15 that ejects the liquid is opened. The nozzle surface 14 is provided at the bottom surface of the head 12 so as to face the downward direction Z2. The head 12 is configured to eject the liquid from the nozzle 15.

The carriage 13 is configured to support the head 12. The carriage 13 moves the head 12 in a state where the head 12 is mounted thereon. The carriage 13 is configured to move forward and backward along the width directions Y. Thus, the width directions Y correspond to an example of scanning directions.

Thus, the carriage 13 is configured to move along the width directions Y while supporting the head 12. The head 12, in the state of being supported by the carriage 13, is movable between a printing area, not illustrated, and a maintenance area 17. The printing area is an area for performing printing on the medium. The maintenance area 17 is an area for performing maintenance of the head 12.

The printing area and the maintenance area 17 are provided side by side in the width directions Y in the liquid ejection device 11. The maintenance area 17 may be provided in the second width direction Y2, as compared with the printing area.

The head 12 is configured to eject the liquid onto the medium in the printing area and thus print an image on the medium. In particular, the head 12 is configured to eject the liquid onto the medium conveyed in the second intersecting direction X2 in the printing area.

### Configuration of Wiping Device 21

The liquid ejection device 11 includes a wiping device 21. The wiping device 21 is provided in the maintenance area 17. The wiping device 21 is a device that wipes the nozzle surface 14 and thus performs maintenance of the nozzle surface 14.

The wiping device 21 includes a wiping member 22, a conveyance unit 23, and a curing unit 30. The wiping member 22 wipes the nozzle surface 14. The wiping member 22 is formed of at least two layers including a first layer 22a and a second layer 22b. The second layer 22b is farther from the nozzle surface 14 than the first layer 22a and is adjacent to the first layer 22a. In the present embodiment, the first layer 22a comes into contact with the nozzle surface 14, thus adsorbs the liquid attached to the nozzle surface 14, and wipes the nozzle surface 14. An adhering substance may adhere to the wiping member 22. As described above, the adhering substance includes the liquid wiped

from the nozzle surface 14, but may include a substance other than the liquid, for example, a foreign matter such as dust in the air. The wiping member 22 may be made of any material that can adsorb the adhering substance, such as cloth. In the wiping member 22, the first layer 22a and the second layer 22b may be made of the same material but may be made of different materials.

The conveyance unit 23 is configured to convey the wiping member 22. The conveyance unit 23 conveys the wiping member 22 in a conveyance direction D in the state of supporting the wiping member 22. The conveyance direction D includes a component along the intersecting directions X.

The conveyance unit 23 includes a reel-out unit 24, a pressing unit 25, and a wind-up unit 26. That is, the liquid ejection device 11 and the wiping device 21 include the reel-out unit 24, the pressing unit 25, and the wind-up unit 26. The wiping member 22 is wound around the reel-out unit 24. The reel-out unit 24 rotates about a rotation axis along the first width direction Y1.

The reel-out unit 24 may include a first reel-out unit 24a and a second reel-out unit 24b. The first reel-out unit 24a and the second reel-out unit 24b rotate about a rotation axis along the first width direction Y1. The first layer 22a of the wiping member 22 is wound around the first reel-out unit 24a. The second layer 22b of the wiping member 22 is wound around the second reel-out unit 24b.

In this manner, the first layer 22a and the second layer 22b, in a separated state, are wound around the reel-out

unit 24. The separated state is a state where the first layer 22a and the second layer 22b are separated from each other. The separated state is a state where there is a gap between the first layer 22a and the second layer 22b.

The pressing unit 25 presses the wiping member 22 against the nozzle surface 14. The pressing unit 25 presses the wiping member 22 in the upward direction Z1. The pressing unit 25 may have a columnar shape extending along the first width direction Y1. The pressing unit 25 may include a pressing roller that comes into contact with the second layer 22b from the downward direction Z2 and an energizing member that energizes the pressing roller in the upward direction Z1.

The pressing unit 25 presses the wiping member 22 wound around the reel-out unit 24 against the nozzle surface 14. The pressing unit 25 presses the first layer 22a wound around the first reel-out unit 24a and the second layer 22b wound around the second reel-out unit 24b against the nozzle surface 14 in a contact state. The contact state is a state where the first layer 22a and the second layer 22b are in contact with each other. The contact state is a state where the first layer 22a and the second layer 22b overlap each other. As described above, in the path between the reel-out unit 24 and the pressing unit 25, the first layer 22a and the second layer 22b change from the separated state to the contact state.

The wind-up unit 26 is configured to wind up the wiping member 22. The wind-up unit 26 rotates about a rotation axis along the first width direction Y1. The wind-up unit 26 is configured to wind up the wiping member 22 reeled out from the reel-out unit 24. The wind-up unit 26 is configured to wind up the wiping member 22 pressed against the nozzle surface 14 by the pressing unit 25. In the path between the pressing unit 25 and the wind-up unit 26, the first layer 22a and the second layer 22b change from the contact state to the separated state.

The wind-up unit 26 may include a first wind-up unit 26a and a second wind-up unit 26b. The first wind-up unit 26a rotates about a rotation axis along the first width direction Y1. The first wind-up unit 26a winds up the first layer 22a of the wiping member 22. The first wind-up unit 26a winds up the first layer 22a reeled out from the first reel-out unit 24a. That is, the first wind-up unit 26a winds up the first layer 22a separated from the second layer 22b.

The second wind-up unit 26b rotates about a rotation axis along the first width direction Y1. The second wind-up unit 26b winds up the second layer 22b. The second wind-up unit 26b winds up the second layer 22b reeled out from the second reel-out unit 24b. That is, the second wind-up unit 26b winds up the second layer 22b separated from the first layer 22a.

The wind-up unit 26 is driven by a wind-up drive unit, not illustrated. The wind-up drive unit is a drive source that drives the wind-up unit 26. The wind-up drive unit may be, for example, a motor. The reel-out unit 24 is driven with the driving of the wind-up unit 26 and thus conveys the wiping member 22 in the conveyance direction D, but may be driven by a reel-out drive unit, not illustrated. The reel-out drive unit is a drive source that drives the reel-out unit 24. The reel-out drive unit may be, for example, a motor.

The curing unit 30 applies energy to the wiping member 22 that has wiped the nozzle surface 14 in the maintenance area 17. The curing unit 30 may be configured to emit ultraviolet rays as energy. Thus, the curing unit 30 cures the liquid attached to the wiping member 22.

The curing unit 30 may include a first curing unit 31, a second curing unit 32, and a third curing unit 33. That is, the liquid ejection device 11 and the wiping device 21 may include the first curing unit 31, the second curing unit 32, and the third curing unit 33. The first curing unit 31 applies energy to the wiping member 22. The first curing unit 31 applies energy to the wiping member 22 and thus cures the liquid wiped by the wiping member 22.

The first curing unit 31 applies energy at a position between the first layer 22a in the separated state and the second layer 22b in the separated state. That is, the first curing unit 31 applies energy to both the first layer 22a in the separated state and the second layer 22b in the separated state. The first curing unit 31 applies energy to the first layer 22a and the second layer 22b that have wiped the liquid from the nozzle surface 14, and thus cures the liquid attached to the first layer 22a and the second layer 22b.

The first curing unit 31 applies energy to the surface previously in contact with the second layer 22b, of the separated first layer 22a. That is, the first curing unit 31 applies energy to the first layer 22a from the side in the downward direction Z2 of the separated first layer 22a.

The first curing unit 31 applies energy to the surface previously in contact with the first layer 22a, of the second layer 22b. That is, the first curing unit 31 applies energy to the second layer 22b from the side in the upward direction Z1 of the separated second layer 22b.

The first curing unit 31 may include a first irradiation unit 41 and a first reflection unit 51. The first irradiation unit 41 casts ultraviolet rays. The first irradiation unit 41 irradiates the first layer 22a and the second layer 22b with ultraviolet rays and thus cures the liquid attached to the first layer 22a and the second layer 22b. The first irradiation unit 41 casts ultraviolet rays at a position between the first layer 22a and the second layer 22b in the separated state.

The first irradiation unit 41 casts ultraviolet rays to the surface previously in contact with the second layer 22b, of the separated first layer 22a. That is, the first irradiation unit 41 irradiates the first layer 22a with ultraviolet rays from the side in the downward direction Z2 of the separated first layer 22a.

The first irradiation unit 41 casts ultraviolet rays to the surface previously in contact with the first layer 22a, of the separated second layer 22b. That is, the first irradiation unit 41 irradiates the second layer 22b with ultraviolet rays from the side in the upward direction Z1 of the separated second layer 22b.

The first reflection unit 51 reflects the ultraviolet rays from the first irradiation unit 41 toward the wiping member 22. The first reflection unit 51 may be any unit that reflects ultraviolet rays as energy. The first reflection unit 51 may reflect at least a part of the ultraviolet rays cast by the first irradiation unit 41, toward the wiping member 22.

The second curing unit 32 applies energy to the wiping member 22 and thus cures the liquid wiped by the wiping member 22. The second curing unit 32 applies energy to the first layer 22a at a position opposite the second layer 22b in the separated state, with the first layer 22a in the separated state located therebetween. The second curing unit 32 applies energy to the first layer 22a and thus cures the liquid attached to the first layer 22a. That is, the second curing unit 32 applies energy to the first layer 22a that has wiped the liquid from the nozzle surface 14, and thus cures the liquid attached to the first layer 22a.

The second curing unit 32 applies energy to the surface that has wiped the nozzle surface 14, of the separated first layer 22a. That is, the second curing unit 32 applies energy to the first layer 22a from the side in the upward direction Z1 of the separated first layer 22a.

The second curing unit 32 may include a second irradiation unit 42 and a second reflection unit 52. The second irradiation unit 42 casts ultraviolet rays. The second irradiation unit 42 casts ultraviolet rays at a position opposite the second layer 22b in the separated state, with the first layer 22a in the separated state located therebetween.

The second irradiation unit 42 casts ultraviolet rays to the surface previously in contact with the nozzle surface 14, of the separated first layer 22a. That is, the second irradiation unit 42 irradiates the first layer 22a with ultraviolet rays from the side in the upward direction Z1 of the separated first layer 22a. The second irradiation unit 42 irradiates the first layer 22a in the separated state with ultraviolet rays and thus cures the liquid attached to the first layer 22a.

The second reflection unit 52 reflects the ultraviolet rays from the second irradiation unit 42 toward the wiping member 22. The second reflection unit 52 may be any unit that reflects ultraviolet rays as energy. The second reflection unit 52 may reflect at least a part of the ultraviolet rays cast by the second irradiation unit 42, toward the wiping member 22.

The third curing unit 33 applies energy to the wiping member 22 and thus cures the liquid wiped by the wiping member 22. The third curing unit 33 applies energy to the second layer 22b at a position opposite the first layer 22a in the separated state, with the second layer 22b in the separated state located therebetween. The third curing unit 33 applies energy to the second layer 22b and thus cures the liquid attached to the second layer 22b.

The third curing unit 33 may output different energy intensities as compared with the first curing unit 31 and the second curing unit 32. The energy intensity output by the third curing unit 33 is lower than the energy intensity output by the first curing unit 31. The energy intensity output by the third curing unit 33 is lower than the energy intensity output by the second curing unit 32.

The third curing unit 33 applies energy to the surface in contact with the pressing unit 25, of the separated second layer 22b. That is, the third curing unit 33 applies energy to the second layer 22b from the side in the downward direction Z2 of the separated second layer 22b. The third curing unit 33 applies energy to the second layer 22b in the separated state and thus cures the liquid attached to the second layer 22b.

Third curing unit 33 may include a third irradiation unit 43 and a third reflection unit 53. The third irradiation unit 43 casts ultraviolet rays. The third irradiation unit 43 casts ultraviolet rays at a position opposite the first layer 22a in the separated state, with the second layer 22b in the separated state located therebetween.

The third irradiation unit 43 casts ultraviolet rays to the surface in contact with the pressing unit 25, of the separated second layer 22b. That is, the third irradiation unit 43 irradiates the second layer 22b with ultraviolet rays from the side in the downward direction Z2 of the separated second layer 22b. The third irradiation unit 43 irradiates the second layer 22b in the separated state with ultraviolet rays and thus cures the liquid attached to the second layer 22b.

The third reflection unit 53 reflects the ultraviolet rays from the third irradiation unit 43 toward the wiping member 22. The third reflection unit 53 may be any unit that reflects ultraviolet rays as energy. The third reflection unit 53 may reflect at least a part of the ultraviolet rays cast by the third irradiation unit 43, toward the wiping member 22.

The liquid ejection device 11 includes a control unit 90. The control unit 90 performs integrated control of the liquid ejection device 11. The control unit 90 controls various operations executed by the liquid ejection device 11. The control unit 90 can be configured as a circuit including α: one or more processors that execute various kinds of processing in accordance with a computer program, β: one or more dedicated hardware circuits that execute at least a part of the various kinds of processing, or γ: a combination of α and β. The hardware circuit is, for example, an application-specific integrated circuit. The processor includes a CPU and a memory such as a RAM and a ROM, and the memory stores program codes or commands configured to cause the CPU to execute processing. The memory, that is, a computer-readable medium, includes any readable medium that can be accessed by a general-purpose or dedicated computer.

### Control of Liquid Ejection Device 11

The control unit 90 displays various information on a display unit, not illustrated. The control unit 90 receives an instruction by a user from an operation unit, not illustrated. The liquid ejection device 11 may be communicable with a terminal device, not illustrated. The controller 90 may receive an instruction by the user from the terminal device.

Upon receiving a print instruction by the user, the control unit 90 moves the carriage 13 from the maintenance area 17 to the printing area along the width direction Y. The control unit 90 moves the carriage 13 forward and backward along the width directions Y in the printing area, ejects the liquid from the nozzle 15 to the medium, and conveys the medium. Thus, the control unit 90 performs printing on the medium according to the print instruction by the user. When the printing is finished, the control unit 90 moves the carriage 13 from the printing area to the maintenance area 17.

When a wiping condition is satisfied, the control unit 90 moves the carriage 13 to a position where the nozzle surface 14 faces the wiping member 22 in the vertical directions Z. The wiping condition may be satisfied during printing, or may be satisfied at the start of printing and at the end of printing.

The controller 90 controls the wiping device 21 to perform wiping in the state where the nozzle surface 14 faces the wiping member 22 in the vertical directions Z. When the wiping of the nozzle surface 14 is finished, the control unit 90 moves the nozzle surface 14 to a position where the nozzle surface 14 does not face the wiping member 22 in the vertical directions Z.

When a conveyance condition is satisfied, the control unit 90 controls the conveyance unit 23 to convey the wiping member 22 in the conveyance direction D. Specifically, the control unit 90 controls the wind-up drive unit, not illustrated, so as to drive the wind-up unit 26, and as the reel-out unit 24 is driven accordingly, the wiping member 22 is conveyed in the conveyance direction D, but the control unit 90 may control a reel-out drive unit, not illustrated, so as to drive the reel-out unit 24.

In the first embodiment, the control unit 90 controls the first wind-up unit 26a and the second wind-up unit 26b such that a first amount of wind-up WA1 of the first wind-up unit 26a and a second amount of wind-up WA2 of the second wind-up unit 26b are the same. That is, the second amount of wind-up WA2 is the same as the first amount of wind-up WA1.

The first amount of wind-up WA1 is an amount by which the first wind-up unit 26a winds up the first layer 22a when the conveyance condition is satisfied once. The first amount of wind-up WA1 may be at least one of the wind-up speed and the wind-up time with which the first wind-up unit 26a winds up the first layer 22a when the conveyance condition is satisfied once.

The second amount of wind-up WA2 is an amount by which the second wind-up unit 26b winds up the second layer 22b when the conveyance condition is satisfied once. The second amount of wind-up WA2 may be at least one of the wind-up speed and the wind-up time with which the second wind-up unit 26b winds up the second layer 22b when the conveyance condition is satisfied once.

The wiping member 22 is conveyed so as to arrive at a position for being pressed in the upward direction Z1 by the pressing unit 25 and such that the region with the liquid attached due to the wiping of the nozzle surface 14 arrives at the curing unit 30. The curing unit 30 cures the liquid attached to the wiping member 22.

The control unit 90 controls the first curing unit 31, the second curing unit 32, and the third curing unit 33 so as to cure the liquid attached to the wiping member 22. In the first embodiment, the control unit 90 may control the first irradiation unit 41, the second irradiation unit 42, and the third irradiation unit 43 so as to cure the liquid attached to the wiping member 22.

### Functions and Effects of First Embodiment

The functions and effects of the first embodiment will be described.

(1-1) The first curing unit 31 applies energy to the first layer 22a and the second layer 22b at a position between the first layer 22a in the separated state and the second layer 22b in the separated state.

With this configuration, energy is applied to the first layer 22a and the second layer 22b by the first curing unit 31 in the state where the wiping member 22 is separated into the first layer 22a and the second layer 22b. Thus, the energy from the first curing unit 31 can be applied more sufficiently to each of the first layer 22a and the second layer 22b than in the state where the first layer 22a and the second layer 22b are not separated. Thus, the drying efficiency of the wiping member 22 can be improved. Therefore, the occurrence of contamination and odor in the liquid ejection device 11 can be reduced.

(1-2) The second curing unit 32 applies energy to the first layer 22a at a position opposite the second layer 22b in the separated state, with the first layer 22a in the separated state located therebetween. With this configuration, energy is applied to the first layer 22a by the second curing unit 32 in the state where the wiping member 22 is separated into the first layer 22a and the second layer 22b. Thus, the energy from the second curing unit 32 can be applied more sufficiently to the first layer 22a than in the state where the first layer 22a and the second layer 22b are not separated. Thus, the drying efficiency of the wiping member 22 can be improved. Therefore, the occurrence of contamination and odor in the liquid ejection device 11 can be reduced.

(1-3) The third curing unit 33 applies energy to the second layer 22b at a position opposite the first layer 22a in the separated state, with the second layer 22b in the separated state located therebetween. With this configuration, energy is applied to the second layer 22b by the third curing unit 33 in the state where the wiping member 22 is separated into the first layer 22a and the second layer 22b. Thus, the energy from the third curing unit 33 can be applied more sufficiently to the second layer 22b than in the state where the first layer 22a and the second layer 22b are not separated. Thus, the drying efficiency of the wiping member 22 can be improved. Therefore, the occurrence of contamination and odor in the liquid ejection device 11 can be reduced.

(1-4) The reel-out unit 24 may include the first reel-out unit 24a around which the first layer 22a is wound and the second reel-out unit 24b around which the second layer 22b is wound. With this configuration, the wiping member 22 is reeled out in the separated state where the wiping member 22 is separated into the first layer 22a and the second layer 22b. Therefore, there is no need to make an adjustment such as superimposing the first layer 22a and the second layer 22b before wiping the nozzle surface 14. Thus, the convenience for the user can be improved. In addition, a mechanism for superimposing the first layer 22a and the second layer 22b in the reel-out unit 24 is not necessary.

(1-5) The wind-up unit 26 includes the first wind-up unit 26a that winds up the first layer 22a, and the second wind-up unit 26b that winds up the second layer 22b separated from the first layer 22a. With this configuration, the wiping member 22 is wound in the separated state where the wiping member 22 is separated into the first layer 22a and the second layer 22b. Therefore, there is no need to make an adjustment such as superimposing the first layer 22a and the second layer 22b after wiping the nozzle surface 14. Thus, the convenience for the user can be improved. In addition, a mechanism for superimposing the first layer 22a and the second layer 22b in the wind-up unit 26 is not necessary.

(1-6) The second amount of wind-up WA2 is the same as the first amount of wind-up WA1. With this configuration, the first amount of wind-up WA1 of the first layer 22a and the second amount of wind-up WA2 of the second layer 22b are the same. Thus, the timing at which the user replaces the first layer 22a and the second layer 22b with new ones can be aligned. Thus, the convenience for the user can be improved.

(1-7) The energy intensity output by the third curing unit 33 is lower than the energy intensity output by the first curing unit 31. With this configuration, the third curing unit 33 can be made to operate with electric power smaller than that of the first curing unit 31. The amount of the liquid wiped from the nozzle surface 14 and held by the second layer 22b, which is farther from the nozzle surface 14 than the first layer 22a, is smaller than the amount of the liquid wiped from the nozzle surface 14 and held by the first layer 22a. Thus, as the energy intensity is changed according to the amount of the liquid held that is wiped from the nozzle surface 14, power consumption can be reduced.

(1-8) The energy intensity output by the third curing unit 33 is lower than the energy intensity output by the second curing unit 32. With this configuration, the third curing unit 33 can be made to operate with electric power smaller than that of the second curing unit 32. The amount of the liquid wiped from the nozzle surface 14 and held by the second layer 22b, which is farther from the nozzle surface 14 than the first layer 22a, is smaller than the amount of the liquid wiped from the nozzle surface 14 and held by the first layer 22a. Thus, as the energy intensity is changed according to the amount of the liquid held that is wiped from the nozzle surface 14, power consumption can be reduced.

(1-9) The first curing unit 31 includes the first irradiation unit 41 that casts ultraviolet rays. With this configuration, the liquid that is cured by the ultraviolet rays can be efficiently cured by the first irradiation unit 41. Thus, the liquid attached to the wiping member 22 can be efficiently cured. Therefore, the occurrence of contamination and odor in the liquid ejection device 11 can be reduced.

(1-10) The first curing unit 31 includes the first reflection unit 51 that reflects the ultraviolet rays from the first irradiation unit 41 toward the wiping member 22. With this configuration, the wiping member 22 can be more efficiently irradiated with the ultraviolet rays from the first irradiation unit 41. Thus, the efficiency of irradiation of the wiping member 22 with the ultraviolet rays from the first irradiation unit 41 can be improved. Therefore, the occurrence of contamination and odor in the liquid ejection device 11 can be reduced.

(1-11) The second curing unit 32 includes the second irradiation unit 42 that casts ultraviolet rays. With this configuration, the liquid that is cured by the ultraviolet rays can be efficiently cured by the second irradiation unit 42. Thus, the liquid attached to the first layer 22a can be efficiently cured. Therefore, the occurrence of contamination and odor in the liquid ejection device 11 can be reduced.

(1-12) The second curing unit 32 includes the second reflection unit 52 that reflects the ultraviolet rays from the second irradiation unit 42 toward the wiping member 22. With this configuration, the first layer 22a can be more efficiently irradiated with the ultraviolet rays from the second irradiation unit 42. Thus, the efficiency of irradiation of the wiping member 22 with the ultraviolet rays from the second irradiation unit 42 can be improved. Therefore, the occurrence of contamination and odor in the liquid ejection device 11 can be reduced.

(1-13) The third curing unit 33 includes the third irradiation unit 43 that casts ultraviolet rays. With this configuration, the liquid that is cured by the ultraviolet rays can be efficiently cured by the third irradiation unit 43. Thus, the liquid attached to the second layer 22b can be efficiently cured. Therefore, the occurrence of contamination and odor in the liquid ejection device 11 can be reduced.

(1-14) The third curing unit 33 includes the third reflection unit 53 that reflects the ultraviolet rays from the third irradiation unit 43 toward the wiping member 22. With this configuration, the second layer 22b can be more efficiently irradiated with the ultraviolet rays from the third irradiation unit 43. Thus, the efficiency of irradiation of the wiping member 22 with the ultraviolet rays from the third irradiation unit 43 can be improved. Therefore, the occurrence of contamination and odor in the liquid ejection device 11 can be reduced.

### Second Embodiment

Next, a second embodiment will be described. In the description below, the repeated description of the same configurations as those of the above-described embodiment will be omitted or simplified, and configurations different from those of the above-described embodiment will be described.

### Control of Amount of Wind-Up

In the second embodiment, the control unit 90 may separately control the first wind-up unit 26a and the second wind-up unit 26b. Specifically, the control unit 90 may control the first wind-up drive unit, not illustrated, to drive the first wind-up unit 26a. The first wind-up drive unit is a drive source that drives the first wind-up unit 26a. The first wind-up drive unit may be, for example, a motor.

The control unit 90 may control the second wind-up drive unit, not illustrated, to drive the second wind-up unit 26b. The second wind-up drive unit is a drive source that drives the second wind-up unit 26b. The second wind-up drive unit may be, for example, a motor.

As illustrated in FIG. 2, the control unit 90 may change at least one of the first amount of wind-up WA1 and the second amount of wind-up WA2 according to an instruction by the user. The control unit 90 may change the first amount of wind-up WA1 and the second amount of wind-up WA2 to be different from each other according to an instruction by the user. In particular, the control unit 90 may be able to change whether to make the second amount of wind-up WA2 equal to the first amount of wind-up WA1 or make the second amount of wind-up WA2 smaller than the first amount of wind-up WA1 according to an instruction by the user. That is, the second amount of wind-up WA2 may be smaller than the first amount of wind-up WA1 according to an instruction by the user.

### Functions and Effects of Second Embodiment

### The functions and effects of the second embodiment will be described.

(2-1) The second amount of wind-up WA2 is smaller than the first amount of wind-up WA1. With this configuration, the second amount of wind-up WA2 of the second layer 22b farther from the nozzle surface 14 than the first layer 22a is smaller than the first amount of wind-up WA1 of the first layer 22a. The amount of the liquid wiped from the nozzle surface 14 and held by the second layer 22b, which is farther from the nozzle surface 14 than the first layer 22a, is smaller than the amount of the liquid wiped from the nozzle surface 14 and held by the first layer 22a. Thus, the second amount of wind-up WA2 of the second layer 22b having a smaller amount of the liquid wiped from the nozzle surface 14 and held therein, of the wiping members 22, can be reduced. Thus, the convenience for the user can be improved.

(2-2) The control unit 90 can change whether to make the second amount of wind-up WA2 equal to the first amount of wind-up WA1 or make the second amount of wind-up WA2 smaller than the first amount of wind-up WA1 according to an instruction by the user. With this configuration, whether to make the second amount of wind-up WA2 equal to the first amount of wind-up WA1 or make the second amount of wind-up WA2 smaller than the first amount of wind-up WA1 can be changed as intended by the user. Thus, the convenience for the user can be improved.

### Third Embodiment

Next, a third embodiment will be described.

### Configuration of Conveyance Unit 23

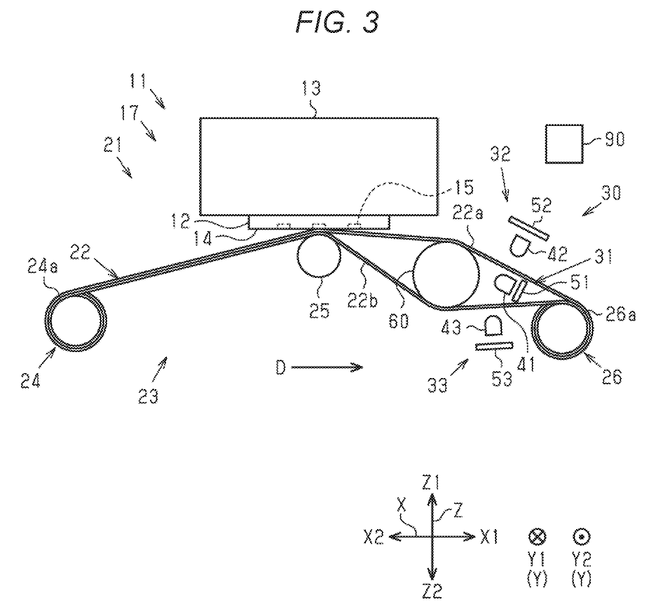

As shown in FIG. 3, in the third embodiment, the reel-out unit 24 may include the first reel-out unit 24a and may not include the second reel-out unit 24b. The wind-up unit 26 may include the first wind-up unit 26a and may not include the second wind-up unit 26b. That is, in the third embodiment, one reel-out unit 24 and one wind-up unit 26 may be provided.

The conveyance unit 23 may include a separation unit 60. The separation unit 60 is configured such that the first layer 22a and the second layer 22b are brought into the separated state in the path between the pressing unit 25 and the wind-up unit 26. The separation unit 60 has a columnar shape extending along the first width direction Y1. The separation unit 60 may be a roller extending along the first width direction Y1. The separator 60 may not have a cylindrical shape.

### Functions and Effects of Third Embodiment

The functions and effects of the third embodiment will be described.

(3-1) The reel-out unit 24 includes the first reel-out unit 24a around which the first layer 22a and the second layer 22b are wound. With this configuration, the structure of the reel-out unit 24 can be simplified. Thus, an increase in the size of the reel-out unit 24 can be suppressed.

(3-2) The wind-up unit 26 includes the first wind-up unit 26a that winds up the first layer 22a and the second layer 22b. With this configuration, the structure of the wind-up unit 26 can be simplified. Thus, an increase in the size of the wind-up unit 26 can be suppressed.

(3-3) The conveyance unit 23 includes the separation unit 60 in the path between the pressing unit 25 and the wind-up unit 26. With this configuration, even when the wind-up unit 26 is simplified, the first layer 22a and the second layer 22b can be brought into the separated state in the path between the pressing unit 25 and the wind-up unit 26.

### Modification Examples

The present embodiments can be implemented with the modifications described below. The present embodiments and the modification examples given below can be implemented in combination with each other as long as no technical inconsistencies are involved.

In the second embodiment, the control unit 90 may be able to change the second amount of wind-up WA2 to be larger than the first amount of wind-up WA1 according to an instruction by the user. The control unit 90 may be able to set the value of the first amount of wind-up WA1 itself according to an instruction by the user. The control unit 90 may be able to set the value of the second amount of wind-up WA2 itself according to an instruction by the user.

In the second embodiment, the control unit 90 may control the first wind-up drive unit and the second wind-up drive unit such that the second amount of wind-up WA2 becomes smaller than the first amount of wind-up WA1 regardless of the instruction by the user. In this way, the second amount of wind-up WA2 may be smaller than the first amount of wind-up WA1.

In the second embodiment, the control unit 90 may be configured to change the amount of wind-up of the wiping member 22 according to the amount of the liquid absorbed by the wiping member 22. The control unit 90 may be configured to change the energy intensity output by the curing unit 30 according to the amount of the liquid absorbed by the wiping member 22. The controller 90 may estimate the amount of the liquid absorbed by the wiping member 22, based on the intensity of maintenance of the head 12. For example, the control unit 90 may estimate that the amount of the liquid absorbed by the wiping member 22 is larger when the intensity of maintenance of the head 12 is high than when the intensity of maintenance of the head 12 is low.

In the third embodiment, the first curing unit 31 may include the first reflecting unit 51. The second curing unit 32 may include the second reflecting unit 52. The third curing unit 33 may include the third reflecting unit 53.

The reel-out unit 24 may be configured to wind up the wiping member 22. In the conveyance unit 23, the wind-up unit 26 is driven by the wind-up drive unit, not illustrated, and as the reel-out unit 24 is driven accordingly, the wiping member 22 is conveyed, but the reel-out unit 24 may be driven by a reel-out drive unit, not illustrated.

As long as the first layer 22a and the second layer 22b are in the separated state at least in the path between the pressing unit 25 and the wind-up unit 26, the first layer 22a and the second layer 22b may be in the contact state or the separated state in other places.

The conveyance direction D may be any direction and is not limited to a direction along the intersecting directions X. The conveyance direction D may be a direction along the width directions Y. The conveyance direction D may include a component along the vertical directions Z.

The second curing unit 32 may be provided in the carriage 13. In particular, the second irradiation unit 42 may be provided in the carriage 13. In such a case, the second irradiation unit 42 may also have a function of curing the liquid ejected onto the medium in the printing area.

The intensity itself of the energy output by the first curing unit 31, the second curing unit 32, and the third curing unit 33 may be different. The output time of the energy output from the first curing unit 31, the second curing unit 32, and the third curing unit 33 may be different, thus causing the intensity of the energy to be different. The intensity itself of the energy output by the first curing unit 31, the second curing unit 32, and the third curing unit 33 and the output time may be different, thus causing the intensity of the energy to be different.

The energy intensity output by the third curing unit 33 may be the same as the energy intensity output by the first curing unit 31. The energy intensity output by the third curing unit 33 may be the same as the energy intensity output by the second curing unit 32. The energy intensity output by the first curing unit 31 may be the same as the energy intensity output by the second curing unit 32. The energy intensity output by the first curing unit 31 may be higher or lower than the energy intensity output by the second curing unit 32. The energy intensity output by the second curing unit 32 may be higher than the energy intensity output by the first curing unit 31 and the energy intensity output by the third curing unit 33.

The wiping member 22 may include at least two layers and may include three or more layers. The first layer 22a may be a layer closer to the nozzle surface 14 than the second layer 22b, and may be an outermost layer in contact with the nozzle surface 14 or may not be the outermost layer. The second layer 22b may be a layer farther from the nozzle surface 14 than the first layer 22a, and may be an outermost layer on the side opposite to the nozzle surface 14 or may not be the outermost layer. The layers of the wiping member 22 may be formed of different materials.

The curing unit 30 may apply energy to the wiping member 22 when the wiping member 22 is wound up by the wind-up unit 26. The curing unit 30 may apply energy to the wiping member 22 when the winding of the wiping member 22 by the wind-up unit 26 is stopped. The curing unit 30 may apply energy to the wiping member 22 when the wiping member 22 is conveyed forward and backward by the reel-out unit 24 and the wind-up unit 26. The curing unit 30 itself may move when the wiping member 22 is stopped. When the wiping member 22 is moving, the curing unit 30 itself may move, too.

The wiping member 22 is not limited to wiping the nozzle surface 14 in the maintenance area 17 and may receive a liquid used for another maintenance. The wiping member 22 may receive the liquid ejected from the nozzle 15 by flushing.

The wiping device 21 may include the second curing unit 32 and the third curing unit 33 without including the first curing unit 31. The wiping device 21 may include the first curing unit 31 and the second curing unit 32 without including the third curing unit 33. The wiping device 21 may include the first curing unit 31 and the third curing unit 33 without including the second curing unit 32. The wiping device 21 may include the first curing unit 31 without including the second curing unit 32 and the third curing unit 33.

The wiping device 21 may be movable along the intersecting directions X. The wiping device 21 may be movable along the width directions Y. The wiping device 21 may wipe the liquid from the nozzle surface 14 by moving. The wiping device 21 may wipe the liquid from the nozzle surface 14 by conveying the wiping member 22.

The pressing unit 25 may be provided so as to press the wiping member 22 toward the nozzle surface 14 at a position that does not overlap the nozzle surface 14 when viewed in a top view, instead of a position that overlaps the nozzle surface 14 when viewed in a top view. The pressing unit 25 may be provided so as to press the wiping member 22 toward the nozzle surface 14 on the first width direction Y1 side and the second width direction Y2 side of the nozzle surface 14 when viewed in a top view. The pressing unit 25 may be provided so as to press the wiping member 22 toward the nozzle surface 14 on the first intersecting direction X1 side and the second intersecting direction X2 side of the nozzle surface 14 when viewed in a top view.

The carriage 13 may be movable along the intersecting directions X instead of the width directions Y. The head 12 may be a serial head type or a line head. When the carriage 13 does not move, the wiping device 21 may move. The wiping device 21 may move along the line head.

The curing unit 30 may apply another type of energy that is not ultraviolet rays to the wiping member 22 and thus cure the liquid wiped by the wiping member 22. The curing unit 30 may be configured to emit, for example, light energy, heat energy, electric energy, or the like. The curing unit 30 may include, for example, a heating unit that emits heat energy.

The medium may be a sheet of paper, a film or sheet made of a resin, a composite film made of a resin and a metal, a laminated film, a woven fabric, a nonwoven fabric, a metal foil, a metal film, a ceramic sheet, clothing, or the like.

The liquid can be freely selected as long as the liquid can adhere to the medium and thus can be printed on the medium. For example, the ink includes an ink formed of a solvent in which particles of a functional material formed of a solid matter such as a pigment or metal particles are dissolved, dispersed, or mixed, and includes various compositions such as an aqueous ink, an oil-based ink, a gel ink, and a hot melt ink.

The expression "at least one of" used in the present specification means one or more of desired options. As an example, when the number of options is two, the expression "at least one of" used in the present specification means only one option or both of the two options. As another example, when the number of options is three or more, the expression "at least one of" used in the present specification means only one option or a combination of any two or more options.

### Appendices

Technical ideas understood from the above-described embodiments and modification examples, and the functions and effects thereof, will be described below. The technical ideas, and the functions and effects thereof can be combined with each other as long as no technical inconsistencies are involved.

[1] A liquid ejection device includes: a head having a nozzle surface where a nozzle that ejects a liquid is opened; a wiping member configured to wipe the nozzle surface; a reel-out unit around which the wiping member is wound; a wind-up unit configured to wind up the wiping member; a pressing unit configured to press the wiping member against the nozzle surface; and a first curing unit configured to apply energy to the wiping member and thus cure the liquid wiped by the wiping member, wherein the wiping member is formed of at least two layers including a first layer and a second layer that is farther from the nozzle surface than the first layer and is adjacent to the first layer, the first layer and the second layer are brought into a separated state in a path between the pressing unit and the wind-up unit, and the first curing unit applies energy to the first layer and the second layer at a position between the first layer in the separated state and the second layer in the separated state.

With this configuration, energy is applied to the first layer and the second layer by the first curing unit in the state where the wiping member is separated into the first layer and the second layer. Thus, the energy from the first curing unit can be applied more sufficiently to each of the first layer and the second layer than in the state where the first layer and the second layer are not separated. Thus, the drying efficiency of the wiping member can be improved. Therefore, the occurrence of contamination and odor in the liquid ejection device can be reduced.

[2] The liquid ejection device may include a second curing unit configured to apply energy to the first layer at a position opposite the second layer in the separated state, with the first layer in the separated state located therebetween. With this configuration, energy is applied to the first layer by the second curing unit in the state where the wiping member is separated into the first layer and the second layer. Thus, the energy from the second curing unit can be applied more sufficiently to the first layer than in the state where the first layer and the second layer are not separated. Thus, the drying efficiency of the wiping member can be improved. Therefore, the occurrence of contamination and odor in the liquid ejection device can be reduced.

[3] The liquid ejection device may include a third curing unit configured to apply energy to the second layer at a position opposite the first layer in the separated state, with the second layer in the separated state located therebetween. With this configuration, energy is applied to the second layer by the third curing unit in the state where the wiping member is separated into the first layer and the second layer. Thus, the energy from the third curing unit can be applied more sufficiently to the second layer than in the state where the first layer and the second layer are not separated. Thus, the drying efficiency of the wiping member can be improved. Therefore, the occurrence of contamination and odor in the liquid ejection device can be reduced.

[4] A liquid ejection device includes: a head having a nozzle surface where a nozzle that ejects a liquid is opened; a wiping member configured to wipe the nozzle surface; a reel-out unit around which the wiping member is wound; a wind-up unit configured to wind up the wiping member; a pressing unit configured to press the wiping member against the nozzle surface; a second curing unit configured to apply energy to the wiping member and thus cure the liquid wiped by the wiping member; and a third curing unit configured to apply energy to the wiping member and thus cure the liquid wiped by the wiping member, wherein the wiping member is formed of at least two layers including a first layer and a second layer that is farther from the nozzle surface than the first layer and is adjacent to the first layer, the first layer and the second layer are brought into a separated state in a path between the pressing unit and the wind-up unit, the second curing unit applies energy to the first layer at a position opposite the second layer in the separated state, with the first layer in the separated state located therebetween, and the third curing unit applies energy to the second layer at a position opposite the first layer in the separated state, with the second layer in the separated state located therebetween.

With this configuration, energy is applied to the first layer and the second layer by the second curing unit and the third curing unit in the state where the wiping member is separated into the first layer and the second layer. Thus, the energy from the second curing unit and the third curing unit can be applied more sufficiently to each of the first layer and the second layer than in the state where the first layer and the second layer are not separated. Thus, the drying efficiency of the wiping member can be improved. Therefore, the occurrence of contamination and odor in the liquid ejection device can be reduced.

[5] The liquid ejection device may include a first curing unit configured to apply energy to the first layer and the second layer at a position between the first layer and the second layer in the separated state. With this configuration, energy is applied to the first layer and the second layer by the first curing unit, the second curing unit, and the third curing unit in the state where the wiping member is separated into the first layer and the second layer. Thus, the energy from the first curing unit, the second curing unit, and the third curing unit can be applied more sufficiently to each of the first layer and the second layer than in the state where the first layer and the second layer are not separated. Thus, the drying efficiency of the wiping member can be improved. Therefore, the occurrence of contamination and odor in the liquid ejection device can be reduced.

[6] In the liquid ejection device, the reel-out unit may include a first reel-out unit around which the first layer is wound, and a second reel-out unit around which the second layer is wound. With this configuration, the wiping member is reeled out in the separated state where the wiping member is separated into the first layer and the second layer. Therefore, there is no need to make an adjustment such as superimposing the first layer and the second layer before wiping the nozzle surface. Thus, the convenience for the user can be improved.

[7] In the liquid ejection device, the wind-up unit may include a first wind-up unit configured to wind up the first layer, and a second wind-up unit configured to wind up the second layer separated from the first layer. With this configuration, the wiping member is wound in the separated state where the wiping member is separated into the first layer and the second layer. Therefore, there is no need to make an adjustment such as superimposing the first layer and the second layer after wiping the nozzle surface. Thus, the convenience for the user can be improved.

[8] In the liquid ejection device, when an amount by which the first wind-up unit winds up the first layer is a first amount of wind-up and an amount by which the second wind-up unit winds up the second layer is a second amount of wind-up, the second amount of wind-up may be smaller than the first amount of wind-up.

With this configuration, the second amount of wind-up of the second layer farther from the nozzle surface than the first layer is smaller than the first amount of wind-up of the first layer. The amount of the liquid wiped from the nozzle surface and held by the second layer, which is farther from the nozzle surface than the first layer, is smaller than the amount of the liquid wiped from the nozzle surface and held by the first layer. Thus, the second amount of wind-up of the second layer having a smaller amount of the liquid wiped from the nozzle surface and held therein, of the wiping members, can be reduced. Thus, the convenience for the user can be improved.

[9] In the liquid ejection device, when an amount by which the first wind-up unit winds up the first layer is a first amount of wind-up and an amount by which the second wind-up unit winds up the second layer is a second amount of wind-up, the second amount of wind-up may be the same as the first amount of wind-up.

With this configuration, the first amount of wind-up of the first layer and the second amount of wind-up of the second layer are the same. Thus, the timing at which the user replaces the first layer and the second layer with new ones can be aligned. Thus, the convenience for the user can be improved.

The liquid ejection device may further include a control unit configured to change a second amount of wind-up according to an instruction by a user, when an amount of winding the first layer by the first wind-up unit is a first amount of wind-up and an amount of winding the second layer by the second wind-up unit is the second amount of wind-up, wherein the control unit may be able to change whether to make the second amount of wind-up equal to the first amount of wind-up or make the second amount of wind-up smaller than the first amount of wind-up according to the instruction by the user.

With this configuration, whether to make the second amount of wind-up equal to the first amount of wind-up or make the second amount of wind-up smaller than the first amount of wind-up can be changed as intended by the user. Thus, the convenience for the user can be improved.

In the liquid ejection device, an energy intensity output by the third curing unit may be lower than an energy intensity output by the first curing unit. With this configuration, the third curing unit can be made to operate with electric power smaller than that of the first curing unit. The amount of the liquid wiped from the nozzle surface and held by the second layer, which is farther from the nozzle surface than the first layer, is smaller than the amount of the liquid wiped from the nozzle surface and held by the first layer. Thus, as the energy intensity is changed according to the amount of the liquid held that is wiped from the nozzle surface, power consumption can be reduced.

In the liquid ejection device, an energy intensity output by the third curing unit may be lower than an energy intensity output by the second curing unit. With this configuration, the third curing unit can be made to operate with electric power smaller than that of the second curing unit. The amount of the liquid wiped from the nozzle surface and held by the second layer, which is farther from the nozzle surface than the first layer, is smaller than the amount of the liquid wiped from the nozzle surface and held by the first layer. Thus, as the energy intensity is changed according to the amount of the liquid held that is wiped from the nozzle surface, power consumption can be reduced.

In the liquid ejection device, the liquid may be a liquid that is cured by irradiation with ultraviolet rays, and the first curing unit may include a first irradiation unit configured to cast ultraviolet rays. With this configuration, the liquid that is cured by the ultraviolet rays can be efficiently cured by the first irradiation unit. Thus, the liquid attached to the wiping member can be efficiently cured. Therefore, the occurrence of contamination and odor in the liquid ejection device can be reduced.

In the liquid ejection device, the first curing unit may include a first reflection unit configured to reflect the ultraviolet rays from the first irradiation unit toward the wiping member. With this configuration, the wiping member can be more efficiently irradiated with the ultraviolet rays from the first irradiation unit. Thus, the efficiency of irradiation of the wiping member with the ultraviolet rays from the first irradiation unit can be improved. Therefore, the occurrence of contamination and odor in the liquid ejection device can be reduced.

In the liquid ejection device, the liquid may be a liquid that is cured by irradiation with ultraviolet rays, and the second curing unit may include a second irradiation unit configured to cast ultraviolet rays. With this configuration, the liquid that is cured by the ultraviolet rays can be efficiently cured by the second irradiation unit. Thus, the liquid attached to the first layer can be efficiently cured. Therefore, the occurrence of contamination and odor in the liquid ejection device can be reduced.

In the liquid ejection device, the second curing unit may include a second reflection unit configured to reflect the ultraviolet rays from the second irradiation unit toward the wiping member. With this configuration, the first layer can be more efficiently irradiated with the ultraviolet rays from the second irradiation unit. Thus, the efficiency of irradiation of the wiping member with the ultraviolet rays from the second irradiation unit can be improved. Therefore, the occurrence of contamination and odor in the liquid ejection device can be reduced.

In the liquid ejection device, the liquid may be a liquid that is cured by irradiation with ultraviolet rays, and the third curing unit may include a third irradiation unit configured to cast ultraviolet rays. With this configuration, the liquid that is cured by the ultraviolet rays can be efficiently cured by the third irradiation unit. Thus, the liquid attached to the second layer can be efficiently cured. Therefore, the occurrence of contamination and odor in the liquid ejection device can be reduced.

In the liquid ejection device, the third curing unit may include a third reflection unit configured to reflect the ultraviolet rays from the third irradiation unit toward the wiping member. With this configuration, the second layer can be more efficiently irradiated with the ultraviolet rays from the third irradiation unit. Thus, the efficiency of irradiation of the wiping member with the ultraviolet rays from the third irradiation unit can be improved. Therefore, the occurrence of contamination and odor in the liquid ejection device can be reduced.

A wiping device includes: a wiping member configured to wipe a nozzle surface where a nozzle that ejects a liquid is opened; a reel-out unit around which the wiping member is wound; a wind-up unit configured to wind up the wiping member; a pressing unit configured to press the wiping member against the nozzle surface; and a first curing unit configured to apply energy to the wiping member and thus cure the liquid wiped by the wiping member, wherein the wiping member is formed of at least two layers including a first layer and a second layer that is farther from the nozzle surface than the first layer and is adjacent to the first layer, the first layer and the second layer are brought into a separated state in a path between the pressing unit and the wind-up unit, and the first curing unit applies energy to the first layer and the second layer at a position between the first layer and the second layer in the separated state. With this configuration, the same effects as in [1] can be achieved.

A wiping device includes: a wiping member configured to wipe a nozzle surface where a nozzle that ejects a liquid is opened; a reel-out unit around which the wiping member is wound; a wind-up unit configured to wind up the wiping member; a pressing unit configured to press the wiping member against the nozzle surface; a second curing unit configured to apply energy to the wiping member and thus cure the liquid wiped by the wiping member; and a third curing unit configured to apply energy to the wiping member and thus cure the liquid wiped by the wiping member, wherein the wiping member is formed of at least two layers including a first layer and a second layer that is farther from the nozzle surface than the first layer and is adjacent to the first layer, the first layer and the second layer are brought into a separated state in a path between the pressing unit and the wind-up unit, the second curing unit applies energy to the first layer at a position opposite the second layer in the separated state, with the first layer in the separated state located therebetween, and the third curing unit applies energy to the second layer at a position opposite the first layer in the separated state, with the second layer in the separated state located therebetween. With this configuration, the same effects as in [4] can be achieved.

What is claimed is:

1. A liquid ejection device comprising:
a head having a nozzle surface where a nozzle that ejects a liquid is opened;
a wiping member configured to wipe the nozzle surface;
a reel-out unit around which the wiping member is wound;
a wind-up unit configured to wind up the wiping member;
a pressing unit configured to press the wiping member against the nozzle surface; and
a first curing unit configured to apply energy to the wiping member and thus cure the liquid wiped by the wiping member, wherein
the wiping member is formed of at least two layers including a first layer and a second layer that is farther from the nozzle surface than the first layer and is adjacent to the first layer,
the first layer and the second layer are brought into a separated state in a path between the pressing unit and the wind-up unit, and
the first curing unit applies energy to the first layer and the second layer at a position between the first layer in the separated state and the second layer in the separated state.

2. The liquid ejection device according to claim 1, further comprising:
a second curing unit configured to apply energy to the first layer at a position opposite the second layer in the separated state, with the first layer in the separated state located therebetween.

3. The liquid ejection device according to claim 1, further comprising:
a third curing unit configured to apply energy to the second layer at a position opposite the first layer in the separated state, with the second layer in the separated state located therebetween.

4. A liquid ejection device comprising:
a head having a nozzle surface where a nozzle that ejects a liquid is opened;
a wiping member configured to wipe the nozzle surface;
a reel-out unit around which the wiping member is wound;
a wind-up unit configured to wind up the wiping member;
a pressing unit configured to press the wiping member against the nozzle surface;
a second curing unit configured to apply energy to the wiping member and thus cure the liquid wiped by the wiping member; and
a third curing unit configured to apply energy to the wiping member and thus cure the liquid wiped by the wiping member, wherein
the wiping member is formed of at least two layers including a first layer and a second layer that is farther from the nozzle surface than the first layer and is adjacent to the first layer,
the first layer and the second layer are brought into a separated state in a path between the pressing unit and the wind-up unit,
the second curing unit applies energy to the first layer at a position opposite the second layer in the separated state, with the first layer in the separated state located therebetween, and
the third curing unit applies energy to the second layer at a position opposite the first layer in the separated state, with the second layer in the separated state located therebetween.

5. The liquid ejection device according to claim 4, further comprising:
a first curing unit configured to apply energy to the first layer and the second layer at a position between the first layer and the second layer in the separated state.

6. The liquid ejection device according to claim 1, wherein
the reel-out unit includes:
a first reel-out unit around which the first layer is wound; and
a second reel-out unit around which the second layer is wound.

7. The liquid ejection device according to claim 1, wherein
the wind-up unit includes:
a first wind-up unit configured to wind up the first layer; and
a second wind-up unit configured to wind up the second layer separated from the first layer.

8. The liquid ejection device according to claim 7, wherein
when an amount by which the first wind-up unit winds up the first layer is a first amount of wind-up, and
an amount by which the second wind-up unit winds up the second layer is a second amount of wind-up,
the second amount of wind-up is smaller than the first amount of wind-up.

9. The liquid ejection device according to claim 7, wherein
when an amount by which the first wind-up unit winds up the first layer is a first amount of wind-up, and
an amount by which the second wind-up unit winds up the second layer is a second amount of wind-up,
the second amount of wind-up is the same as the first amount of wind-up.

10. The liquid ejection device according to claim 7, further comprising:
a control unit configured to change a second amount of wind-up according to an instruction by a user,
when an amount of winding the first layer by the first wind-up unit is a first amount of wind-up, and
an amount of winding the second layer by the second wind-up unit is the second amount of wind-up, wherein
the control unit is configured to be able to change whether to make the second amount of wind-up equal to the first amount of wind-up or make the second amount of wind-up smaller than the first amount of wind-up according to the instruction by the user.

11. The liquid ejection device according to claim 3, wherein
an energy intensity output by the third curing unit is lower than an energy intensity output by the first curing unit.

12. The liquid ejection device according to claim 4, wherein
an energy intensity output by the third curing unit is lower than an energy intensity output by the second curing unit.

13. The liquid ejection device according to claim 1, wherein
the liquid is a liquid that is cured by irradiation with ultraviolet rays, and
the first curing unit includes a first irradiation unit configured to cast ultraviolet rays.

14. The liquid ejection device according to claim 13, wherein
the first curing unit includes a first reflection unit configured to reflect the ultraviolet rays from the first irradiation unit toward the wiping member.

15. The liquid ejection device according to claim 2, wherein
the liquid is a liquid that is cured by irradiation with ultraviolet rays, and
the second curing unit includes a second irradiation unit configured to cast ultraviolet rays.

16. The liquid ejection device according to claim 15, wherein
the second curing unit includes a second reflection unit configured to reflect the ultraviolet rays from the second irradiation unit toward the wiping member.

17. The liquid ejection device according to claim 3, wherein
the liquid is a liquid that is cured by irradiation with ultraviolet rays, and
the third curing unit includes a third irradiation unit configured to cast ultraviolet rays.

18. The liquid ejection device according to claim 17, wherein
the third curing unit includes a third reflection unit configured to reflect the ultraviolet rays from the third irradiation unit toward the wiping member.

19. A wiping device comprising:
a wiping member configured to wipe a nozzle surface where a nozzle that ejects a liquid is opened;
a reel-out unit around which the wiping member is wound;
a wind-up unit configured to wind up the wiping member;
a pressing unit configured to press the wiping member against the nozzle surface; and
a first curing unit configured to apply energy to the wiping member and thus cure the liquid wiped by the wiping member, wherein
the wiping member is formed of at least two layers including a first layer and a second layer that is farther from the nozzle surface than the first layer and is adjacent to the first layer,
the first layer and the second layer are brought into a separated state in a path between the pressing unit and the wind-up unit, and
the first curing unit applies energy to the first layer and the second layer at a position between the first layer and the second layer in the separated state.

20. A wiping device comprising:
a wiping member configured to wipe a nozzle surface where a nozzle that ejects a liquid is opened;
a reel-out unit around which the wiping member is wound;
a wind-up unit configured to wind up the wiping member;
a pressing unit configured to press the wiping member against the nozzle surface;
a second curing unit configured to apply energy to the wiping member and thus cure the liquid wiped by the wiping member; and
a third curing unit configured to apply energy to the wiping member and thus cure the liquid wiped by the wiping member, wherein
the wiping member is formed of at least two layers including a first layer and a second layer that is farther from the nozzle surface than the first layer and is adjacent to the first layer,
the first layer and the second layer are brought into a separated state in a path between the pressing unit and the wind-up unit,
the second curing unit applies energy to the first layer at a position opposite the second layer in the separated state, with the first layer in the separated state located therebetween, and
the third curing unit applies energy to the second layer at a position opposite the first layer in the separated state, with the second layer in the separated state located therebetween.
